(19) United States
(12) Patent Application Publication
(10) Pub. No.: US 2026/0112103 A1
(43) Pub. Date: Apr. 23, 2026

(54) METHOD FOR THE GENERATION OF TRUE ORTHOPHOTOS BASED ON NOVEL VIEW SYNTHESIS

(71) Applicant: LEICA GEOSYSTEMS AG, Heerbrugg (CH)

(72) Inventors: Martina BEKROVÁ, Prague (CZ); Tomáš NOVÀK, Prague (CZ); Tomáš PAZDIORA, Olomouc (CZ); Jan ZAPLETAL, Ostrava-Poruba (CZ)

(73) Assignee: LEICA GEOSYSTEMS AG, Heerbrugg (CH)

(21) Appl. No.: 19/362,870

(22) Filed: Oct. 20, 2025

(30) Foreign Application Priority Data
Oct. 23, 2024 (EP) 24 208 373.1

(51) Int. Cl. G06T 15/08; G06T 7/12; G06T 15/20; G06T 15/60; G06V 10/762

(52) U.S. Cl. CPC G06T 15/08; G06T 7/12; G06T 15/20; G06T 15/60; G06V 10/762

(57) ABSTRACT

A method for creating true orthophotos of a scene from a plurality of input images. The method comprises receiving a set of digital input images, camera calibration parameters, and a structure represented by a point cloud. Further, it comprises initializing a scene representation as a plurality of Gaussian distributions, each comprising a set of trainable parameters. The method also comprises selecting a digital input image as a training image and performing novel view synthesis based on the scene representation to produce a render of the scene. The render of the scene is utilized to compute a derivative with respect to the trainable parameters of each of the plurality of Gaussian distributions for updating a set of trainable parameters of one or more of the plurality of Gaussian distributions. The training process may be repeated multiple times until a condition is met.

### BACKGROUND

The present disclosure pertains to a computer-implemented method for creating true orthophotos of a scene from a plurality of input images. Specifically, the method comprises producing a scene representation with a 3D Gaussian Splatting algorithm by utilizing the plurality of input images. The produced scene representation may be used to generate true orthophotos of the scene by performing novel view synthesis.

An orthophoto is an aerial photograph or image geometrically corrected (“orthorectified”) in such a way that the photo has the same lack of distortion as a map. Thus, unlike an uncorrected aerial photograph, an orthophoto may be used to measure true distances because it is an accurate representation of the Earth's surface. In other words, the rectification is intended to adjust for unwanted optical effects, such as camera tilt, lens distortion, perspective distortion, topographic reliefs, and occlusions. Due to this adjustment, referred to as orthorectification, an orthophoto represents the orthographic projection of the captured embodiment onto an image plane. In other words, the underlying surface is accurately represented. In particular, perspective is removed and variations in terrain are taken into account, wherein typically multiple geometric transformations are applied to the image, depending on the perspective and terrain corrections required on a particular part of the image. Orthophotos can be used to measure true distances and angles. In case of the common usage for aerial imagery, the underlying surface corresponds to the surface of Earth, following a map projection.

Merging a plurality of orthophotos results in an orthophoto mosaic. Adding marginal information, such as cartographical data, either to orthophotos or orthophoto mosaics results in orthophoto maps. By way of example, orthophotos are commonly used in geographic information systems (GIS) as a “map accurate” background image, e.g. to create maps, wherein the images are aligned, or “registered”, with known real-world coordinates.

In theory, an image taken from infinite distance produces a true orthophoto, as every spot would be orthogonally projected onto the image plane. It is common practice to take images from high elevation, such as from airborne or satellite systems, to emulate this effect. However, due to the angular field of view of a camera, the resulting images will always comprise unwanted oblique views. For example, these oblique views might comprise facades of buildings or occlusions caused by terrestrial reliefs.

In order to differentiate an orthophoto in the desired form (no oblique views) from a commonly used approximation of an orthophoto that comprises some oblique views, the term “true orthophoto” was introduced. A true orthophoto does not comprise oblique views, as it is an orthogonal projection of the underlying surface. An orthogonal projection represents three-dimensional objects in two dimensions in which all the projection lines are orthogonal to the projection plane, which, in the case of orthophotos, refers to the surface of the Earth.

It is known to generate orthophotos (unlike a “true orthophoto”) and orthophoto maps from aerial images based on digital terrain models (DTM). A DTM represents the bare ground surface of Earth without any objects (plants or buildings). Due to the lack of the height information of such structures, orthophotos generated on the base of such models entail errors and artifacts in the images because of wrong height assumptions. Hence, to generate a “true orthophoto” or “true orthophoto map”, one can use a digital surface model (DSM). A DSM holds all the information of the DTM but additionally comprises information of both, natural and artificial objects, such as trees and buildings.

To generate a DSM, one can either use direct LIDAR measurement or imagery acquired by a plane or UAV (and possibly enhanced by LIDAR). The data is processed in a computer vision pipeline producing a mesh representing the covered scene. The mesh is then rasterized into the DSM. However, in the final orthophoto generation this too will lead to artifacts if the proxy mesh/DSM is not accurate. This is a common case, e.g. for thin structures (poles, wires) which are difficult to mesh as 3D objects, vegetation, or edges (transition between roof and pavement).

Gaussian Splatting is an algorithm that can be used for performing novel view synthesis. “Novel view synthesis” (also known as “view synthesis”) describes the process of generating images of a specific object or scene from a point of view based on images from different viewpoints. In Gaussian Splatting, a plurality of three-dimensional Gaussian distributions (ellipsoids) is arranged to create a model of an object. Each Gaussian distribution is individually configured by parameters such as position, orientation, scale, and opacity. The term “splatting” refers to the rendering of an image, where the 3D Gaussians (ellipsoids) are projected as ellipses onto a 2D image plane of the camera. “Rendering” or “image synthesis” refers to the process of generating an image from a model by means of a computer program. The resulting image is referred to as the render.

An initialized scene representation might not represent a scene in a precise manner. As a result, the render might comprise artifacts or other errors and inaccuracies. However, as 3D Gaussian splatting is a differentiable rendering technique, the scene representation can be improved. Therefore, the parameters of the individual Gaussian distributions are adapted during an optimization process with the intention for the combination of all Gaussian distributions to reconstruct the object as close as possible. Differentiable rendering allows to compute a derivative of the difference between the output, which is the render, and the input, which is the digital input image. Then, the parameters of the model, i.e. the Gaussian distributions, can be updated to approximate the scene more accurately and improve the quality of the scene representation and thus the quality of the generated renders.

In other words, the Gaussian Splatting algorithm can be trained using common training processes utilized in machine learning. For instance, firstly, a model is initialized. Then, an image is chosen from the set of training images. Next, the model is used to reconstruct and render the scene from the same point of view as the training image using view synthesis. Subsequently, the difference between the real image and the reconstructed render is computed. This difference reflects the training loss. Finally, a backwards pass is performed to optimize the trainable parameters using an optimization scheme. In some instances, the optimization might be conducted using a gradient-based optimization technique. Gradient-based optimization refers to well-known algorithms used in the machine learning domain, such as “gradient descent” or the “conjugate gradient” method. This process is repeated until a condition is met.

By means of example, the condition might be met after a pre-defined number of iterations. For instance, the number of iterations could be thirty thousand. It is noted that the number of iterations could be any other natural number as well.

By means of another example, the condition might be met once the training loss falls below a pre-defined threshold value. Other examples might further comprise computing a quantifier, such as a norm, of the difference between the real image and the reconstructed render and comparing it to a threshold value, whereas the condition is met once the quantifier falls below said threshold value.

The Gaussian splatting algorithm can be initialized with a point cloud that can be extracted from image data, for example by using a structure-from-motion (SfM) algorithm or directly from LIDAR measurements. Prior to the training process, each point in the point cloud can be replaced with a Gaussian distribution to initialize the model. Therefore, the positions of the Gaussian distributions are given by the corresponding points in the point cloud, and the other (non-positional) parameters are initialized by some constant.

Semantic segmentation is a process in computer vision where individual pixels or a cluster of pixels are assigned to an object class. These classes usually refer to an object type or its usage.

Land-use maps are orthographic maps that are semantically segmented to visualize the use of the underlying land, i.e. roads, agricultural land, buildings, forests, etc.

Semantic segmentation can also be used to classify and remove objects that are undesired in an image. In EP 4 170 582 for instance, this process is used to classify and remove (moving) vehicles from aerial street images. Besides the vehicles, also the adjacent road pixels depicting a shadow of the vehicles can be removed to avoid artifacts.

### SUMMARY

In view of the above circumstances, a first object of the present disclosure is to provide a computer-implemented method to produce a 3D scene representation of a scene from a plurality of input images.

A second object is to provide a computer-implemented method to generate true orthophotos of a scene from a 3D scene representation based on input images.

A third object is to provide a computer-implemented method to conduct the combination of the first object and the second object.

The present disclosure utilizes Gaussian Splatting for the reconstruction of a scene representation (the model) of a scene based on the available images. Furthermore, novel view synthesis is used to generate new images from this scene representation. When rendering an orthogonal projection of this model, a true orthophoto is generated.

A first aspect pertains to a computer-implemented method for generating a representation of a scene.

The computer-implemented method comprises receiving a set of digital input images captured by one or more cameras, the set of digital input images comprising a multitude of digital input images, each input image comprising a timestamp and depicting at least a part of the scene from an aerial view. The method further comprises receiving camera calibration parameters of each of the one or more cameras. Also, the method comprises receiving a structure represented by a point cloud. Additionally, the method comprises initializing the scene representation as a plurality of Gaussian distributions, wherein each Gaussian distribution is defined by a set of trainable parameters comprising position, orientation, scale, colour, and opacity parameters and wherein the positions of one or more of the Gaussian distributions are initialized with the position of one or more points in the point cloud. The method further comprises training a 3D Gaussian Splatting algorithm to produce an improved scene representation. Training comprises selecting one of the digital input images of the subset as a training image and performing novel view synthesis based on the scene representation to produce a render of the scene from the same viewpoint as the training image and comparing the render to the training image and adjusting the scene representation by updating the set of trainable parameters of one or more of the plurality of Gaussian distributions.

In some embodiments, the render may be achieved by splatting, as it is described above.

According to this aspect, the input images are clustered according to their timestamp into a plurality of groups. In this aspect, a trainable parameter that describes an image luminance is added to the set of trainable parameters of one or more Gaussian distributions for each group. Furthermore, the colour and/or opacity parameters of one or more Gaussian distributions are adapted according to the luminance described by the trainable parameter of the group of the training image. Moreover, the trainable parameters of the group of the training image of one or more Gaussian distributions is updated.

According to some embodiments, when initializing the scene representation as a plurality of Gaussian distributions, each trainable parameter of the set of trainable parameters of each Gaussian distributions is set to a initialization value. The initialization values might vary among the set of different trainable parameters.

According to some embodiments of the method, training the 3D Gaussian Splatting algorithm comprises receiving a structure represented by a point cloud. For instance, training the 3D Gaussian Splatting algorithm further comprises initializing the position of the plurality of Gaussian distributions to match at least part of the position of the points of the structure. In some embodiments, at least one trainable parameter is initialized to a constant value. In some embodiments, the structure that is represented by a point-cloud is generated by one of LIDAR measurements, a structure from motion (SfM) algorithm or range imaging.

According to some embodiments of the method, the digital input images comprise images primarily taken from nadir points of view. In other embodiments of the method, the digital input images comprise images primarily taken from oblique points of view. In other embodiments of the method, the digital input images are equally taken from nadir and from oblique points of view.

According to some embodiments of the method, one or more of the digital input images comprise black-and-white images.

According to some embodiments of the method, one or more of the digital input images comprise RGB colour images.

According to some embodiments of the method, one or more of the digital input images comprise near-infrared data. In some embodiments, the near-infrared data is being added as an additional trainable parameter to the set of trainable parameters of one or more of the Gaussian distributions.

According to some embodiments of the method, one or more of the digital input images comprise a separate channel for semantic segmentation data.

According to some embodiments of the method, one or more of the digital input images are customized based on the semantic segmentation data. For instance, one or more trainable parameters of one or more Gaussian distributions are adjusted based on the semantic segmentation data. In some embodiments, Gaussian distributions are removed or modified based on the semantic segmentation data.

For instance, vehicles and the corresponding shadows might not be desired to be comprised by a true orthophoto. Especially moving vehicles (and shadows) might introduce artifacts, if not every digital input image depicts the same situation. In order to avoid that, the pixels belonging to said vehicles, as well as the pixels belonging to the vehicle's shadows, may be removed from the digital input image based on the semantic segmentation data. Note that semantic segmentation of an object may differ between different images and different points of view. In case of contradicting semantic segmentation data between digital input images, in some embodiments, the corresponding Gaussian distributions may be removed from the digital input image in order to avoid possible artifacts. As it is unlikely that relevant information would be falsely segmented in all digital input images it would be unlikely for the relevant information to be lost in the resulting scene representation.

A second aspect pertains to performing novel view synthesis based on the trained scene representation according to the first aspect in order to generate one or more true orthophotos of the scene. In some embodiments, this might be achieved by Gaussian Splatting of the plurality of Gaussian distributions as it is explained above.

According to some embodiments of the method, when generating a true orthophoto, a luminance of the rendered scene is chosen according to the group that covers most of the scene. In some embodiments, this might be determined by the number of Gaussian distributions of which the trainable parameter corresponding to the relevant group deviates from an initial value.

According to some embodiments of the method, when generating a true orthophoto, when the scene is covered by a plurality of groups, a luminance of the rendered scene is chosen according to a distance measure determined by the distance between the camera parameters corresponding to the digital input images of said groups and the Gaussian distributions.

According to some embodiments of the method, one or more of the produced true orthophotos of the scene comprise near-infrared data.

According to some embodiments of the method, the near-infrared data is added to the resulting true orthophoto in a separate channel.

According to some embodiments of the method, the semantic segmentation data is visualized in the resulting true orthophoto. For instance, the resulting true orthophoto represents a land-use map.

According to some embodiments of the method, depth information is extracted from the scene representation to produce one or more depth images, the depth images being colourized to visualize the depth information based on a distance measure of each Gaussian distribution.

According to some embodiments of the method, one or more digital surface model (DSM) maps are produced based on the one or more depth images.

According to some embodiments, the first aspect and the second aspect are combined.

The disclosure also pertains to a computer program comprising instructions which, when the program is executed by a computer, cause the computer to carry out the first aspect and/or the second aspect.

The disclosure also pertains to a computer-readable data carrier having stored thereon the computer program according to the first aspect and/or according to the second aspect, or a data carrier signal carrying the computer program according to the first aspect and/or according to the second aspect.

### BRIEF DESCRIPTION OF THE DRAWINGS

Aspects will be described in detail by referring to exemplary embodiments that are accompanied by figures, in which:

FIGS. 1a and 1b show an orthophoto (non-true) and a true orthophoto of a building, wherein the actual footprint of the building is visualized by a dash-dotted line;

FIG. 2a shows a scene captured by an aerial camera with oblique views and obscured areas;

FIG. 2b shows an orthogonal projection of a scene onto an image plane as it is captured by a true orthophoto;

FIG. 3 shows a digital surface model (DSM) of a scene comprising natural and artificial immovable structures;

FIG. 4a shows an orthophoto of a residential property comprising visible artifacts (highlighted by dashed ellipses), rendered by a conventional orthophoto generation method;

FIG. 4b shows an orthophoto of a residential property without visible artifacts as rendered;

FIG. 5a shows a scene captured by a plurality of cameras from different points of view;

FIG. 5b shows an orthogonal projection of the scene of FIG. 5a;

FIG. 6 shows a simplified exemplary reconstruction of an object by modifying a plurality of gaussians;

FIGS. 7a and 7b show an aerial image from a scene comprising a highway and multiple vehicles and the semantic segmentation of the scene, respectively;

FIG. 8 shows a flowchart illustrating steps of an exemplary embodiment of a method for training a 3D Gaussian Splatting algorithm; and

FIG. 9 shows an exemplary computer system for performing a method.

### DETAILED DESCRIPTION

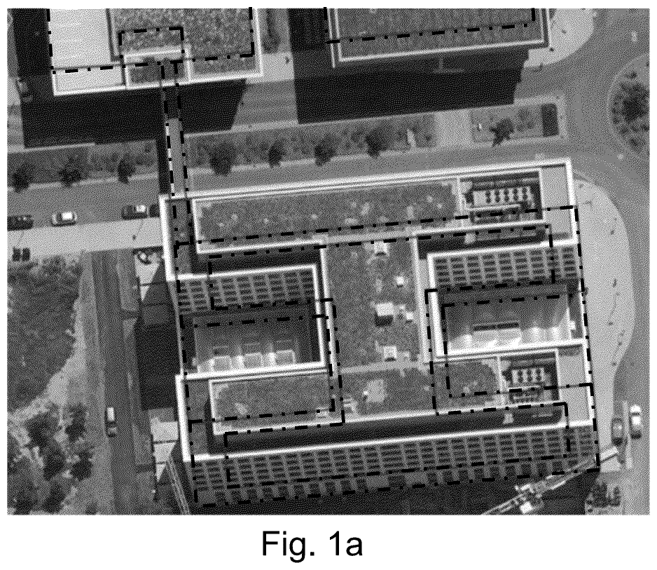

FIG. 1a shows an orthophoto of a building as it is produced by conventional methods, i.e. not a true orthophoto. Due to the camera perspective, the building façade is partially visible while certain areas, such as the pavement and part of the street behind the building are hidden. Black dash-dotted lines were added to visualize the actual footprint of the building on the ground. Moreover, the oblique point of view of the non-true orthophoto might introduce perspective distortions, which means that precise measurements of distances or angles directly from the images are not possible.

FIG. 1b shows a true orthophoto of the same building as depicted in FIG. 1a with the footprint of the building being visualized by a black dash-dotted line. Since true orthophotos show the orthographic projection of a scene, a true orthophoto does not contain concealed areas and is not affected by perspective distortion. As can be seen in this example, no building façades are visible and the complete pavement as well as the street can be seen in the image. Advantageously, true orthophotos may be used for precise measurements of distances and angles.

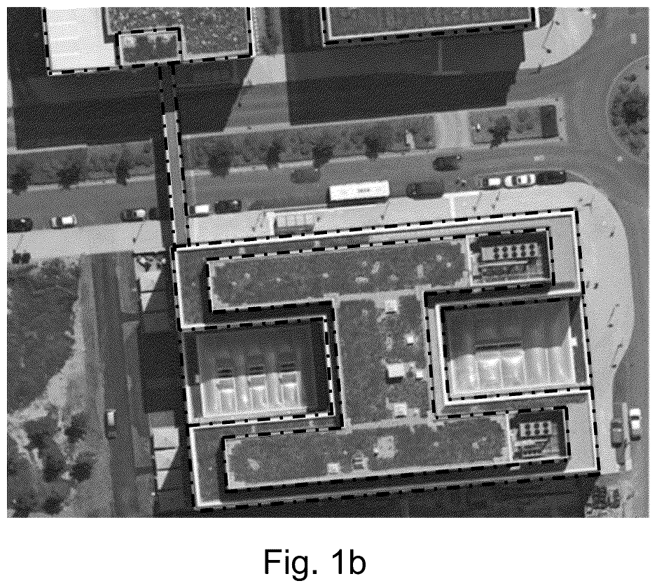

FIG. 2a shows a scene captured by an aerial camera as it might be used for the creation of a conventional orthophoto. Due to the camera's perspective, the resulting image comprises oblique views while certain areas are not visible to the camera. Additionally, perspective distortion might prevent the resulting image from being usable for precise measurements. FIG. 2b shows the orthogonal projection of the same scene as in FIG. 2a, as it might be used to create a true orthophoto. True orthophotos do not comprise occlusions or oblique views. Hence, areas which might have been hidden in a conventional orthophoto are comprised by the true orthophoto.

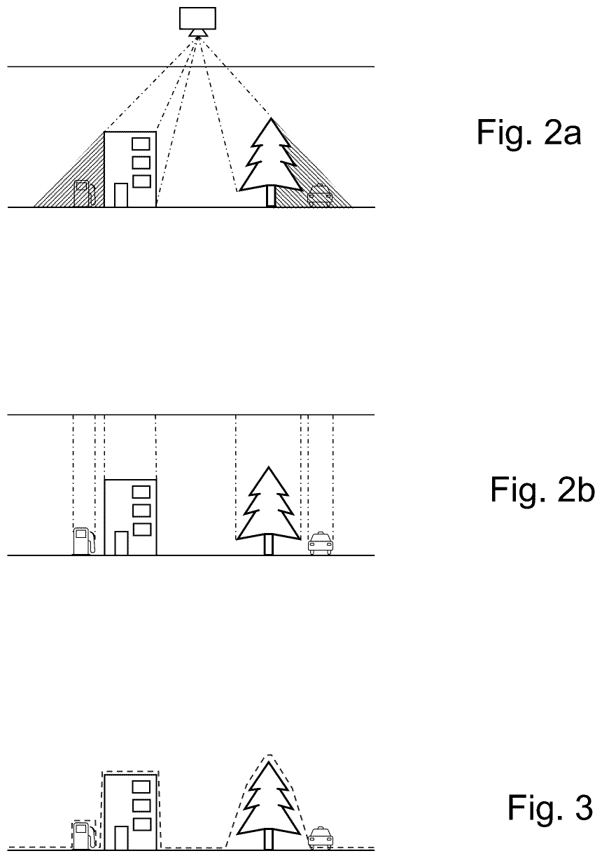

FIG. 3 shows a digital surface model (DSM) of the same scene as in FIGS. 2a and 2b. The digital surface model represents the ground surface of the Earth and comprises height information of artificial and natural structures. Moving objects, such as cars, are not part of a DSM.

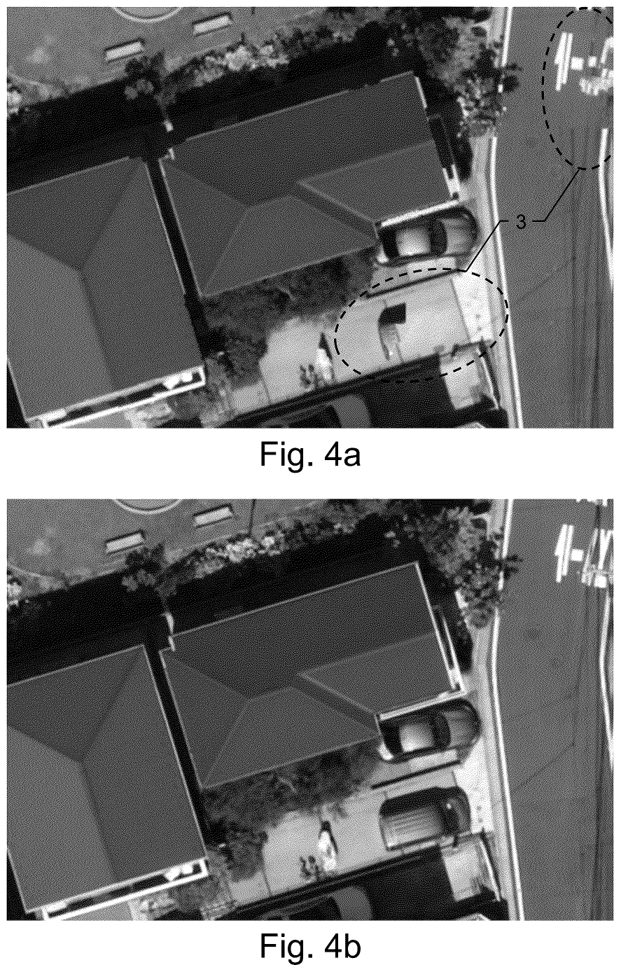

FIG. 4a shows a true orthophoto of a residential property generated by a conventional orthophoto-generation method based on a digital surface model (DSM). Depending on the accuracy of the height map or the underlying mesh, a variety of artifacts 3 can occur in the resulting true orthophoto.

FIG. 4b shows the same scene as in FIG. 4a, generated by a method according to the second aspect. As no depth map, DSM, or underlying mesh is utilized to create this model, artifacts comparable to FIG. 4a are not visible.

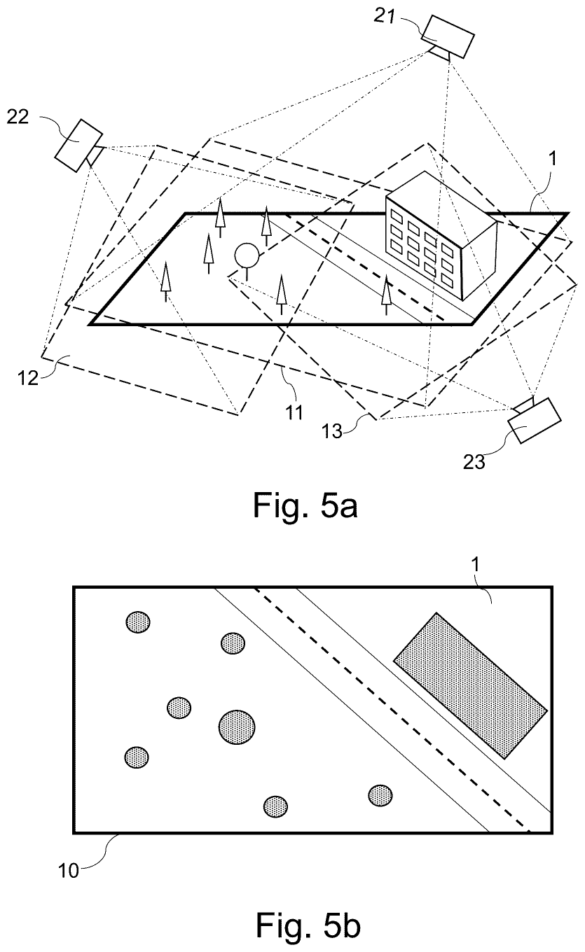

FIG. 5a shows a plurality of cameras 21-23 with different positions and orientations capturing at least part of a scene 1 as a method according to the first aspect might use as digital input images 11-13. The individual images might not comprise the complete scene and may comprise concealed areas. In some instances, images might be black and white, whereas others comprise RGB colours. In some instances, the images might comprise near-infrared data.

FIG. 5b shows a true orthophoto of the scene of FIG. 5a after being processed by a method according to the second aspect. The true orthophoto is the orthogonal projection of an object, or in this case the orthogonal projection of the scene. No oblique views are comprised by the resulting true orthophoto.

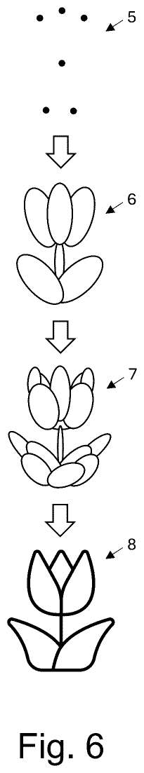

FIG. 6 shows a simplified example of object reconstruction using a plurality of Gaussian distributions. In the present example, in a first step a point cloud 5 is provided. Next, each point in the point cloud is replaced by a Gaussian distribution 6. Then, each Gaussian distribution is adjusted by its parameters in the training process, whereas new Gaussian distributions can be added to the model 7. After a number of training iterations, the plurality of Gaussian distributions is intended to collectively represent the object 8.

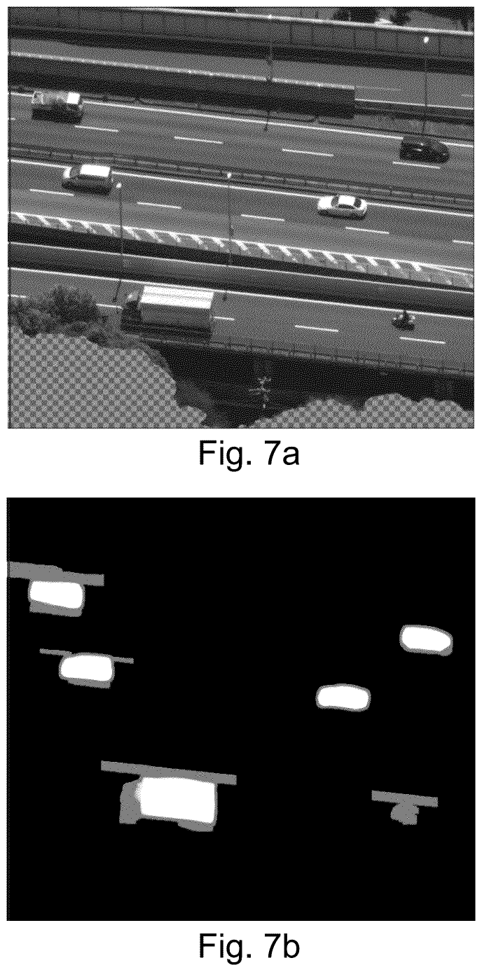

FIG. 7a shows a captured scene of a highway comprising multiple vehicles, whereas FIG. 7b shows the pixel-wise semantic segmentation of the same scene. The semantic segmentation differentiates semantic classes such as vehicles, vehicle shadows and other pixels. The semantic segmentation is conducted, for instance, by conventional algorithms based on neural networks. This information gained from the semantic segmentation can be used to modify or remove objects from training images, for example vehicles and vehicle shadows. To assess to which semantic class a pixel belongs, a score can be computed. In some embodiments it has proven to be preferable to remove undesired objects if their segmentation does not correspond to the segmentation of other training images, in order to avoid artifacts in the scene representation.

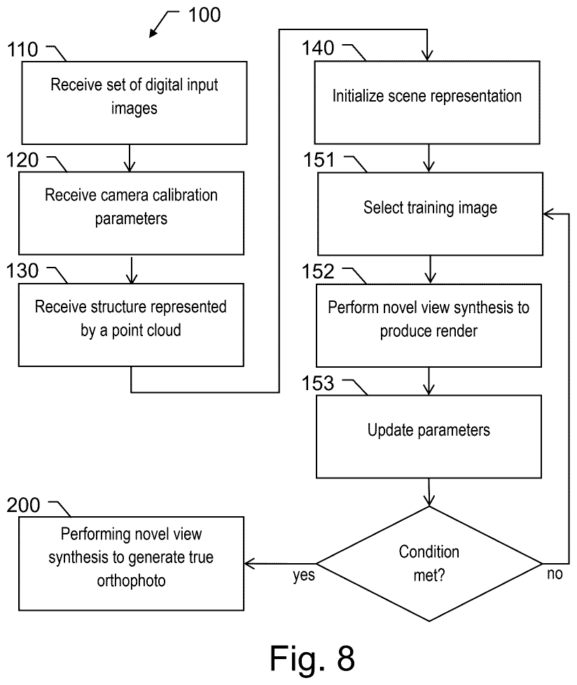

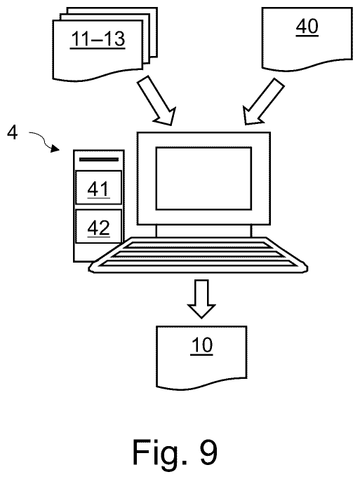

FIG. 8 shows a flow chart illustrating an exemplary embodiment of a method 100 for training a 3D Gaussian Splatting algorithm. The method might be executed on a computer system, as it can be seen in the exemplary depiction of FIG. 9. However, it is noted that the disclosure also pertains to other means of computation. A person skilled in the art is aware of the possibility to transmit data gathered in the scope to other computing means, such as an external server, a cloud, or similar, for processing.

The method starts with receiving 110 a set of digital input images captured by one or more cameras, each image comprising a timestamp and depicting at least a part of the scene from an aerial view.

The method continues with receiving 120 camera calibration parameters of each of the one or more cameras. Camera calibration parameters may comprise information regarding the position and orientation of the cameras.

Next, the method comprises receiving 130 a structure represented by a point cloud.

Then, the scene representation is initialized 140 as a plurality of Gaussian distributions. Each Gaussian distribution is defined by a set of trainable parameters comprising position, orientation, scale, colour and opacity parameters. Additionally, the positions of one or more of the Gaussian distributions are initialized with the position of one or more points in the point cloud.

Next, the method continues with training a 3D Gaussian Splatting algorithm using at least a subset of the set of digital input images to produce an improved scene representation.

In the shown exemplary embodiment, the training comprises steps 151, 152 and 153. These steps may be repeated multiple times. In one step, one of the digital input images of the subset is chosen 151 as a training image. In another step, novel view synthesis is performed 152 based on the scene representation to produce a render of the scene from the same viewpoint as the training image. In another step, the render is compared to the training image and the scene representation is adjusted by updating 153 the set of trainable parameters of one or more of the plurality of Gaussian distributions. These steps may be repeated multiple times in the training process. In case the training process is repeated, the produced improved scene representation might be used for the subsequent iteration of the training process. In some embodiments the training process may be repeated until a condition is met. By means of example, the condition might be met once the training process is repeated for thirty thousand iterations.

In a next step, novel view synthesis is performed 200 based on the produced improved scene representation to produce one or more true orthophotos of the scene. It is noted that the one or more true orthophotos are intended to not comprise any oblique views or other unwanted effects, such as topographic reliefs, lens distortion, or camera tilt.

FIG. 9 illustrates an exemplary computer system for executing a method according to the first aspect and/or the second aspect. The depicted computer 4 comprises a processing unit 41 and a storage unit 42. The storage unit 42 is configured to store algorithms for executing the method, i.e. 3D Gaussian Splatting algorithms. It is also configured to store received input data, generated output data and any intermediate data generated in the process. The computer 4 receives as input at least the set of digital input images of the scene and the camera calibration parameters and calculates and outputs true orthophotos of the scene. Of course, instead of a single computer 4 as shown here, cloud computing may be used as well. The true orthophotos may be output on a display of the computer 4, printed and/or provided to other computer systems, e.g. via an internet connection.

1. A computer-implemented method for generating a representation of a scene, the method comprising:
receiving a set of digital input images captured by one or more cameras, the set of digital input images comprising a multitude of digital input images, each input image comprising a timestamp and depicting at least a part of the scene from an aerial view;
receiving camera calibration parameters of each of the one or more cameras;
receiving a structure represented by a point cloud;
initializing the scene representation as a plurality of Gaussian distributions, wherein each Gaussian distribution is defined by a set of trainable parameters comprising position, orientation, scale, colour, and opacity parameters and wherein the positions of one or more of the Gaussian distributions are initialized with the position of one or more points in the point cloud;
training a 3D Gaussian Splatting algorithm to produce an improved scene representation, the training comprising:
selecting one of the digital input images of the subset as a training image,
performing novel view synthesis based on the scene representation to produce a render of the scene from the same viewpoint as the training image, and
comparing the render to the training image and adjusting the scene representation by updating the set of trainable parameters of one or more of the plurality of Gaussian distributions,
wherein the input images are clustered according to their timestamp into a plurality of groups, wherein training the 3D Gaussian Splatting algorithm comprises:
for each group adding a trainable parameter to the set of trainable parameters of one or more Gaussian distributions, the trainable parameter describing an image luminance;
adapting the colour and/or opacity parameters of one or more Gaussian distributions according to the luminance described by the trainable parameter of the group of the training image; and
updating the trainable parameters of the group of the training image for one or more Gaussian distributions.

2. The method according to claim 1, wherein:
initializing the scene representation comprises initializing at least one trainable parameter to a constant value for at least a subset of the plurality of Gaussian distributions; and/or
the structure represented by a point cloud comprises being generated by one of LIDAR measurements, a structure from motion algorithm, and range imaging.

3. The method according to claim 1, wherein the digital input images comprise:
images primarily taken from nadir points of view; or
images primarily taken from oblique points of view; or
images equally taken from nadir and oblique points of view.

4. The method according to claim 1, wherein the digital input images comprise RGB colour images.

5. The method according to claim 1, wherein one or more of the digital input images comprise near-infrared data.

6. The method according to claim 5, wherein the set of trainable parameters comprises a near-infrared parameter.

7. The method according to claim 1, wherein one or more of the digital input images further comprise a separate channel for semantic segmentation data.

8. The method according to claim 7, comprising customizing the digital input images based on the semantic segmentation data, wherein customizing comprises adjusting one or more trainable parameters of one or more Gaussian distributions based on the semantic segmentation data.

9. The method according to claim 8, wherein customizing comprises removing or modifying Gaussian distributions based on the semantic segmentation data.

10. The method according to claim 9, wherein the Gaussian distributions to be removed or modified comprise semantic segmentation for one or more vehicles, in particular comprising removing or modifying the shadow of one or more vehicles.

11. The method according to claim 1, wherein the method comprises performing novel view synthesis based on a produced scene representation to generate one or more true orthophotos of the scene.

12. A computer-implemented method for generating one or more true orthophotos of a scene, each orthophoto depicting a geometrically rectified image of a surface of the scene, the method comprising performing novel view synthesis based on a produced scene representation to generate one or more true orthophotos of the scene, wherein the scene representation is an improved scene representation produced by a 3D Gaussian Splatting algorithm that has been trained according to the method of claim 1.

13. The method according to claim 12, wherein, when generating a true orthophoto, a luminance of the rendered scene is chosen according to the group that covers most of the scene.

14. The method according to claim 12, wherein one or more of the digital input images comprise:
a separate channel for semantic segmentation data and producing one or more true orthophotos of the scene comprises visualizing the semantic segmentation data, particularly producing land-use maps; and/or
near-infrared data and the produced one or more true orthophotos of the scene comprise near-infrared data.

15. The method according to claim 12, comprising extracting depth information from the scene representation to produce one or more depth images, the depth image being colourized to visualize the depth information based on a distance measure of each Gaussian distribution, in particular comprising producing one or more digital surface model (DSM) maps based on the one or more depth images.

16. A computer program comprising instructions stored in a non-transitory computer-readable medium which, when the program is executed by a computer, cause the computer to carry out the method of claim 1.

17. A computer program comprising instructions stored in a non-transitory computer-readable medium which, when the program is executed by a computer, cause the computer to carry out the method of claim 12.
